(19) United States
(12) Patent Application Publication
(10) Pub. No.: US 2026/0350984 A1
(43) Pub. Date: Nov. 5, 2026

(54) CAPTION GENERATION APPARATUS, CAPTION GENERATION METHOD, AND NON-TRANSITORY COMPUTER READABLE MEDIUM

(71) Applicant: TOYOTA JIDOSHA KABUSHIKI KAISHA, Aichi-ken (JP)

(72) Inventors: Rajat SAINI, Edogawa-ku (JP); Quan KONG, Toshima-ku (JP); Norimasa KOBORI, Nakano-ku (JP); Shizen KITAZAKI, Hachioji-shi (JP)

(21) Appl. No.: 19/653,114

(22) Filed: Apr. 21, 2026

(30) Foreign Application Priority Data
Apr. 28, 2025 (JP) 2025-074928

(51) Int. Cl. G06V 20/40; G06F 40/40; G06V 10/25; G06V 10/774

(52) U.S. Cl. CPC G06V 20/41; G06F 40/40; G06V 10/25; G06V 10/774; G06V 20/49

(57) ABSTRACT

A caption generation apparatus for generating captions for instances in a moving image includes an acquisition interface and a controller. The acquisition interface acquires a moving image. The controller segments the acquired moving image based on scene transitions, and detects instances in one of multiple frames included in each segmented scene. The controller tracks the instances across multiple frames included in the same scene, and assigns captions to the instances in each frame included in the same scene. The controller combines multiple captions assigned to the same instance in the multiple individual frames included in the same scene.

### CROSS-REFERENCE TO RELATED APPLICATION

This application claims priority to Japanese Patent Application No. 2025-74928, filed on Apr. 28, 2025, the entire contents of which are incorporated herein by reference.

### TECHNICAL FIELD

The present disclosure relates to a caption generation apparatus, a caption generation method, and a non-transitory computer readable medium.

### BACKGROUND

Technology for generating, from moving images, captions (descriptive sentences) for instances contained in the moving images using machine learning models has been proposed. For example, Patent Literature (PTL) 1 proposes technology for automatically generating, from visual information in the metaverse space, comment text spoken by characters.

### CITATION LIST

### Patent Literature

PTL 1: WO 2024/224928 A1

### SUMMARY

There is room for improvement in technology for generating captions for individual instances contained in moving images.

It would be helpful to improve technology for generating captions for instances contained in moving images.

A caption generation apparatus according to an embodiment of the present disclosure is a caption generation apparatus for generating a caption for an instance in a moving image, the caption generation apparatus including:
an acquisition interface configured to acquire a moving image; and
a controller configured to:
   segment the acquired moving image based on a scene transition;
   detect an instance in one of multiple frames included in each segmented scene;
   track the instance across multiple frames included in the same scene;
   assign a caption to the instance in each frame included in the same scene; and
   combine multiple captions that are assigned to the same instance in the multiple individual frames included in the same scene.

A caption generation method according to an embodiment of the present disclosure is a caption generation method executed by a controller of a caption generation apparatus for generating a caption for an instance in a moving image, the caption generation method including:
acquiring a moving image;
segmenting the acquired moving image based on a scene transition;
detecting an instance in one of multiple frames included in each segmented scene;
tracking the instance across multiple frames included in the same scene;
assigning a caption to the instance in each frame included in the same scene; and
combining multiple captions that are assigned to the same instance in the multiple individual frames included in the same scene.

A program according to an embodiment of the present disclosure is configured to cause a controller of a caption generation apparatus for generating a caption for an instance in a moving image to execute operations, the operations including:
acquiring a moving image;
segmenting the acquired moving image based on a scene transition;
detecting an instance in one of multiple frames included in each segmented scene;
tracking the instance across multiple frames included in the same scene;
assigning a caption to the instance in each frame included in the same scene; and
combining multiple captions that are assigned to the same instance in the multiple individual frames included in the same scene.

According to the present disclosure, it is possible to improve technology for generating captions for instances contained in moving images.

### BRIEF DESCRIPTION OF THE DRAWINGS

In the accompanying drawings:

FIG. 1 is a block diagram illustrating a schematic configuration of a caption generation system according to an embodiment of the present disclosure;

FIG. 2 is a flowchart of caption generation processing executed by a controller of a caption generation apparatus in FIG. 1;

FIG. 3 is a diagram explaining the procedure of the caption generation processing;

FIG. 4 is a diagram explaining an example of instance tracking; and

FIG. 5 is a diagram illustrating a method for generating instance captions according to a comparative example.

### DETAILED DESCRIPTION

Visual language models (VLMs) are known as multimodal machine learning models capable of handling text information and image information including moving images. For example, the visual language models can take moving images as input, and output sentences (captions) that describe the input moving images.

To train the visual language models to enhance the recognition of individual instances contained in the moving images, datasets that include captions for instances in moving images are required. However, many conventional models for generating captions from moving images only generate captions for the entire images, and cannot generate detailed captions for individual instances. An embodiment of the present disclosure described below aims to generate a detailed caption for each instance contained in a moving image.

In the present disclosure, an instance refers to an individual object, such as a specific object, person, or animal, contained in an image. A caption refers to descriptive sentences that accompany an image or video. A caption for an instance is descriptive sentences that explain the instance. Hereinafter, a caption for an instance may be referred to as “instance caption.”

An embodiment of the present disclosure will be described below, with reference to the drawings.

### Caption Generation System

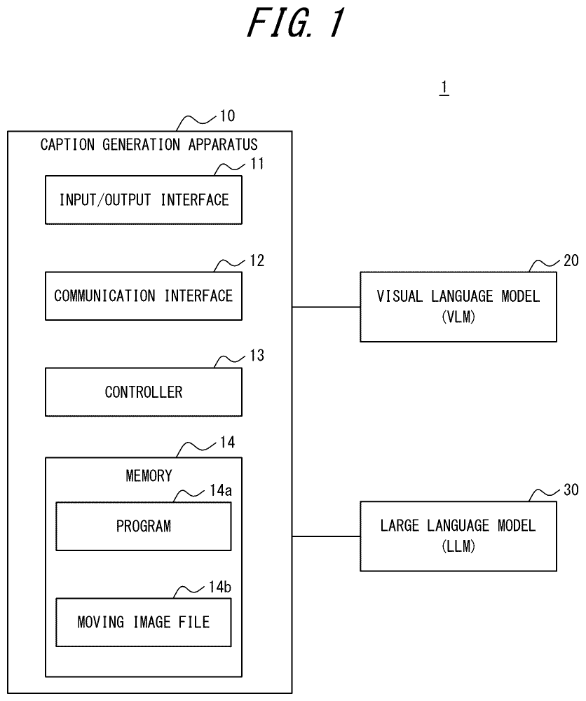

FIG. 1 is a diagram illustrating a schematic configuration of a caption generation system 1 according to the embodiment of the present disclosure. The caption generation system 1 includes a caption generation apparatus 10, a visual language model 20, and a large language model (LLM) 30.

### Configuration of Caption Generation Apparatus

The caption generation apparatus 10 generates, from a moving image, instance captions for instances contained in the moving image. The caption generation apparatus 10 is, for example, a computer such as a server apparatus. The caption generation apparatus 10 may be a general purpose computer, or a dedicated computer specialized for the functions of the caption generation apparatus 10. The caption generation apparatus 10 may be a server apparatus belonging to a cloud computing system. In the embodiment, as illustrated in FIG. 1, the caption generation apparatus 10 includes an input/output interface 11, a communication interface 12, a controller 13, and a memory 14.

The input/output interface 11 includes input devices such as a keyboard and a mouse and output devices such as a display for inputting/outputting information from/to a user operating the caption generation apparatus 10. The input/output interface 11 further includes a device connection interface that transfers data between the caption generation apparatus 10 and other devices connected to the caption generation apparatus 10. The device connection interface includes an interface compliant with various standards including Universal Serial Bus (USB), High-Definition Multimedia Interface (HDMI®: HDMI is a registered trademark in Japan, other countries, or both), IEEE 1394, Serial Advanced Technology Attachment (SATA), and the like.

The communication interface 12 is hardware and software for transmitting/receiving information to/from other information processing apparatuses. The communication interface 12 includes a wired communication-compatible interface and a wireless communication-compatible interface. The wired communication-compatible interface includes a communication interface compliant with a wired LAN standard such as Ethernet or IEEE 802.3. The wireless communication-compatible interface includes an interface compliant with wireless communication standards such as 3rd generation mobile communication system (3G), 4th generation mobile communication system (4G) including Long Term Evolution (LTE), 5th generation mobile communication system (5G), and Wi-Fi® (Wi-Fi is a registered trademark in Japan, other countries, or both). The caption generation apparatus 10 may communicate with the visual language model 20 and/or the large language model 30 via the communication interface 12.

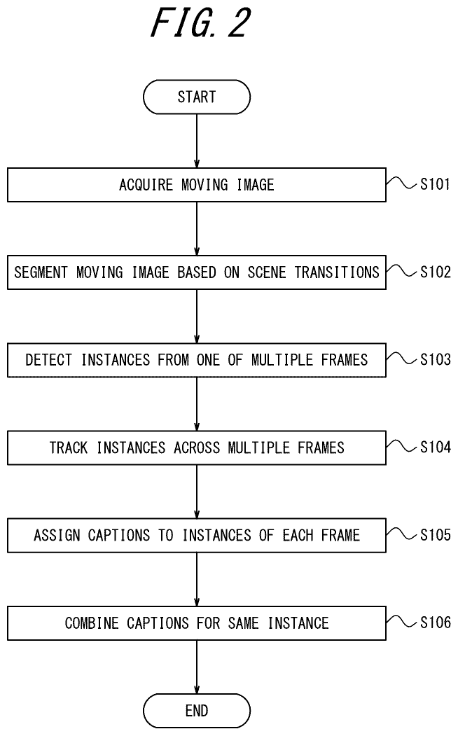

The controller 13 includes at least one processor, at least one dedicated circuit, or a combination thereof. The processor is a general purpose processor, such as a central processing unit (CPU) or a graphics processing unit (GPU), or a dedicated processor dedicated to specific processing. The dedicated circuit is, for example, a field-programmable gate array (FPGA) or an application specific integrated circuit (ASIC). The controller 13 executes processing related to operations of the caption generation apparatus 10 while controlling components of the caption generation apparatus 10. The processing executed by the controller 13 will be described below with reference to a flowchart of FIG. 2.

The memory 14 includes at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memory 14 functions as, for example, a main memory, an auxiliary memory, or a cache memory. The memory 14 stores programs and data to be used for operations of the caption generation apparatus 10, and data obtained by operations of the caption generation apparatus 10. The memory 14 may store a program 14a to be executed by the controller 13, and a moving image file 14b that stores a moving image for which the controller 13 generates instance captions.

The functions of the caption generation apparatus 10 are realized by execution of the program 14a by a processor corresponding to the controller 13. That is, the functions of the caption generation apparatus 10 are realized by software. The program 14a enables the computer to function as the caption generation apparatus 10 by causing the computer to execute the operations of the caption generation apparatus 10. That is, the computer functions as the caption generation apparatus 10 by executing the operations of the caption generation apparatus 10 in accordance with the program 14a.

In the present embodiment, the program 14a can be recorded on a computer readable recording medium. The computer readable recording medium includes a non-transitory computer readable medium and is, for example, a magnetic recording apparatus, an optical disc, a magneto-optical recording medium, or a semiconductor memory. The program 14a is distributed, for example, by selling, transferring, or lending a portable recording medium such as a digital versatile disc (DVD) or a compact disc read only memory (CD-ROM) on which the program 14a is recorded. The program 14a may also be distributed by storing the program 14a in a storage of an external server and transmitting the program 14a from the external server to another computer. The program 14a may be provided as a program product.

### Visual Language Model and Large Language Model

The visual language model 20 is a pre-trained artificial intelligence model designed for text information and image information, and can process visual information such as images and/or videos and language information such as text in an integrated manner. The visual language model 20 can accept input of an image, and generate captions that describe the content of the image. The visual language model 20 is, for example, Large Language Model Meta AI (Llama) 3.2, but is not limited to this. As the visual language model 20, any machine learning model designed for visual information and text can be used.

The large language model 30 is a pre-trained artificial intelligence model that has learned a large amount of text data. The large language model 30 can perform processing such as text generation, question answering, and summarization of sentences. The large language model 30 is a model such as Generative Pre-trained Transformer (GPT) or Bidirectional Encoder Representations from Transformers (BERT). The large language model 30 is not limited to these and can utilize any large language model.

The visual language model 20 and the large language model 30 may be installed in a server apparatus that is disposed in a nearby or remote location communicably with the caption generation apparatus 10. Alternatively, the visual language model 20 and the large language model 30 may be installed in a server apparatus belonging to a cloud computing system. The caption generation apparatus 10 and the server apparatus in which the visual language model 20 and the large language model 30 are installed may be communicable via a communication network such as the Internet. Alternatively, the visual language model 20 and the large language model 30 may be installed in the same computer as the caption generation apparatus 10. Furthermore, the visual language model 20 and the large language model 30 may be the same multimodal model (multimodal LLM) that can handle both images and text.

### Instance Caption Generation Processing

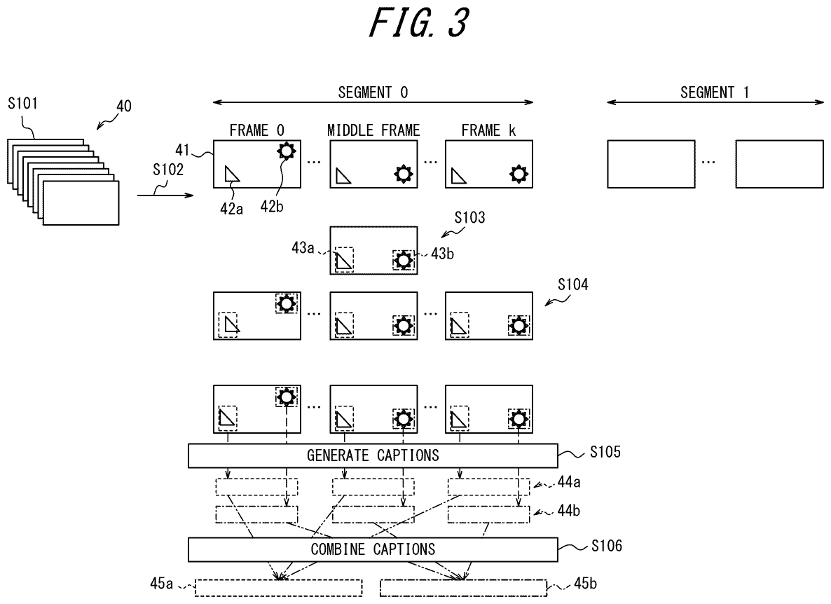

Instance caption generation processing executed by the controller 13 of the caption generation apparatus 10 will be described below with reference to FIGS. 2 and 3. FIG. 3 explains a flow of processing for each step of the flowchart of FIG. 2 using a simple illustration.

First, the controller 13 acquires a moving image 40 from outside the caption generation apparatus 10 or from the moving image file 14b stored in the memory 14 (S101). The moving image 40 acquired by the controller 13 may be in any format such as MPEG-4 Part 14 (MP4), Audio Video Interleave (AVI), WebM, or Advanced Video Coding High Definition (AVCHD®: AVCHD is a registered trademark in Japan, other countries, or both).

The controller 13 divides the moving image 40 into multiple segments based on scene transitions (S102). When the entire moving image has switched, the controller 13 may determine that the scene has transitioned and segment the moving image at the switching. More specifically, the controller 13 may calculate the difference in pixel values over sequential frames 41, and determine that the scene has transitioned when this difference is greater than a predetermined value. Alternatively, the controller 13 may calculate the histogram of color distribution for each frame 41, and determine that the scene has transitioned when the difference in this histogram over sequential frames is greater than a predetermined value. The controller 13 may determine that the scene has transitioned using a machine learning model that has learned scene switching patterns using a large amount of moving image data. For example, a learning model called AutoShot can be utilized as a method for detecting scene switching in the moving image. Each segmented moving image includes multiple frames 41.

The controller 13 extracts instances 42a and 42b from one of the multiple frames 41 included in each scene (S103). To detect the instances 42a and 42b from an image of a frame 41, a machine learning model for object detection can be used. As the machine learning model for object detection, for example, GroundingDINO can be used. This machine learning model can detect and track objects in images based on text instructions. To detect the instances 42a and 42b in the moving image, another object detection model such as You Only Look Once (YOLO) or Faster Region-based Convolutional Neural Network (Faster R-CNN) may also be used. A user of the caption generation apparatus 10 may adjust the types of instances that the controller 13 can detect, by adjusting instructions to the object detection model. For example, the user may instruct the object detection model to detect only people and animals.

In S103, the controller 13 may select a frame 41 located in the middle of the time-series frames 41 included in the same segment, and extract the instances 42a and 42b contained in that frame 41. The controller 13 preferably extracts every instance 42a or 42b that is detectable in the middle frame. By extracting the instances 42a and 42b from the frame 41 located in the temporal middle, it becomes easier to extract the instances 42a and 42b contained in more frames 41 of that scene. The middle frame 41 does not necessarily have to be a frame 41 located exactly at the center among the time-series frames 41 in the scene. The middle frame 41 may be a frame 41 located approximately in the temporal middle in the scene. The frame 41 from which the instances 42a and 42b are extracted in S103 is not limited to the approximately middle frame 41, and may be, for example, a first frame 41 or a last frame 41.

The controller 13 determines rectangular bounding boxes 43a and 43b that enclose the instances 42a and 42b, respectively. The bounding boxes 43a and 43b are determined based on segmentation masks that have detected by object detection. Each of the bounding boxes 43a and 43b is represented by specifying the coordinates of the top-left corner and the bottom-right corner of the rectangle.

The controller 13 tracks the instances 42a and 42b across multiple frames 41 in the segment. When the instances 42a and 42b are detected in the frame 41 located in the temporal middle in S103, the controller 13 sequentially tracks the instances 42a and 42b in the preceding and subsequent frames (S104). That is, tracking the instances 42a and 42b may include temporally forward tracking and temporally backward tracking. To track the instances 42a and 42b, methods such as the Kalman filter method and/or optical flow method can be used. Alternatively, the controller 13 may track the instances 42a and 42b using a machine learning model that has learned object tracking patterns using a large amount of moving image data.

In each frame 41, the controller 13 determines bounding boxes 43a and 43b enclosing the instances 42a and 42b, respectively. The bounding boxes 43a and 43b indicate the position and size of the instances 42a and 42b within the frame image. By comparing the position and size across the frames 41, the bounding boxes 43a and 43b can be used for the purpose of tracking the movement of the instances 42a and 42b.

The controller 13 inputs the image of each frame 41 and the images of the individual bounding boxes 43a and 43b in the frame 41 separately into the visual language model 20, to acquire a caption for each of the instances 42a and 42b in each frame 41. A caption for an instance in a single frame image is referred to as a frame-level instance caption. The controller 13 assigns acquired frame-level instance captions 44a and 44b to the instances 42a and 42b, respectively (S105). The controller 13 sequentially stores, in the memory 14, the frame-level instance captions 44a and 44b for the instances 42a and 42b for each frame 41.

The controller 13 combines, for the same instance 42a or 42b, multiple frame-level instance captions 44a or 44b generated and assigned for individual frames 41, to generate an instance caption for the moving image of the entire segment (S106). Specifically, the controller 13 inputs multiple frame-level instance captions 44a or 44b into the large language model 30 to combine those captions. The large language model 30 generates, from the frame-level instance captions 44a or 44b, a single instance caption that summarizes the overall movement. The frame-level instance captions 44a or 44b are thereby combined into a single instance caption that summarizes operations of the instance across the moving image of the entire segment. The instance caption for the moving image of the entire segment is referred to as a moving image-level instance caption 45a or 45b.

### EXAMPLE

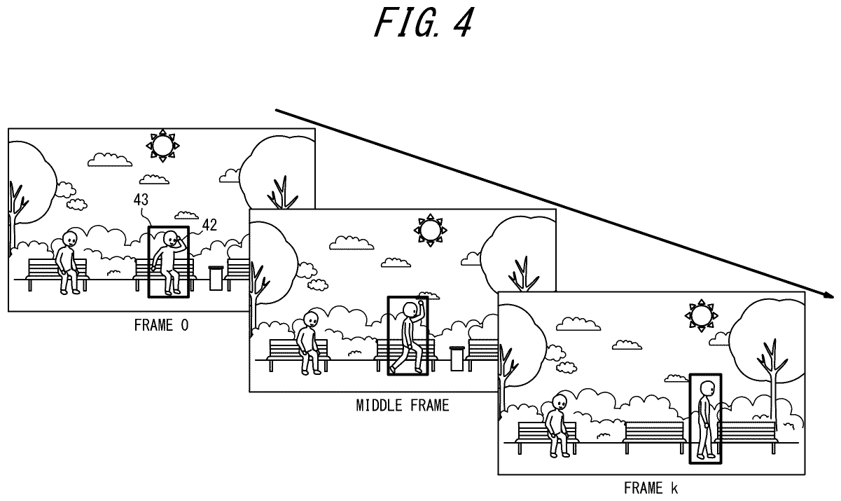

An example of integrating frame-level instance captions into a moving image-level instance caption is explained with reference to FIG. 4. FIG. 4 contains, as instances 42, three benches in a park, two people sitting on different benches, the sun, clouds, and multiple trees. The controller 13 generates a caption for every detectable instance 42. In the following description, a man who is initially sitting on a middle bench is taken as an example of an instance 42.

When a moving image of a segment includes frames 0 to k, the controller 13 first detects the instance 42 in a middle frame, which is located in the temporal middle. The controller 13 tracks the instance 42 of the man detected in the middle frame with respect to preceding and subsequent frames in the time series. The controller 13 assigns a bounding box 43 enclosing the instance 42 to every frame. The controller 13 transmits the image within the bounding box 43 to the visual language model 20, to acquire a frame-level instance caption for the instance 42 in each frame.

In the example of FIG. 4, a frame-level instance caption for the frame 0 is, for example, as follows:
“A man is sitting on a middle bench in a park. The man is wearing a white shirt and brown long pants. The man is looking to the left with his left hand on his forehead.”

A frame-level instance caption for the middle frame is, for example, as follows:
“A man stands up from a bench and is trying to walk, facing his body towards the right in front of the bench. The man is waving with his left hand.”

A frame-level instance caption for the frame k is, for example, as follows:
“A man is near the area between a middle bench and a right bench. The man is walking towards the right.”

The controller 13 inputs the frame-level instance captions from the frame 0 to the frame k into the large language model 30 to generate a moving image-level instance caption. As an example, the moving image-level instance caption for the instance 42 is as follows:
“A man wearing a white shirt and brown long pants is initially sitting on a bench in a park. Next, the man stands up, turns to the right, and waves with his left hand. After that, the man walks to the right and comes between the middle bench and a right bench.”

The controller 13 may detect every detectable instance in the middle frame. The controller 13 generates, for every instance detected in the middle frame, a frame-level instance caption for each frame, and combines such frame-level instance captions to generate a moving image-level instance caption. This allows the controller 13 to generate a moving image-level instance caption for each of the instances such as people, benches, the sun, clouds, and trees.

As described above, the caption generation apparatus 10 according to the present disclosure accepts input of a moving image, and automatically generates captions for instances contained in the moving image. The instance captions generated as described above can be used as a training dataset for visual language models in a learning phase, along with the moving image. These visual language models are different models from the visual language model 20 in FIG. 1. This allows the visual language models to be trained to better recognize the movements of instances.

### Comparative Example

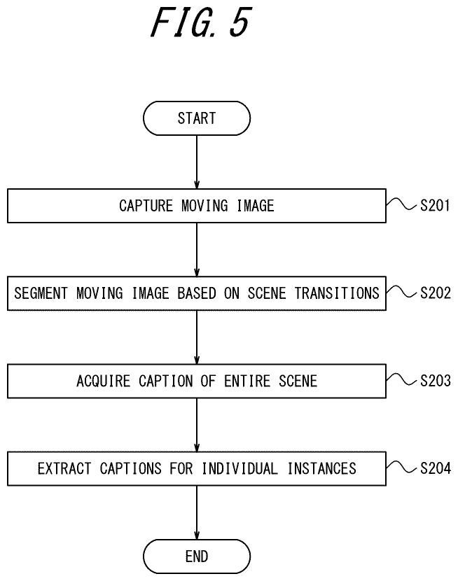

As a method for generating captions for instances, it is conceivable to cause the visual language model to generate a caption for an entire moving image and extract a caption for each instance from the generated caption. FIG. 5 illustrates an example of a processing flow of this method. The flow of FIG. 5 is briefly described as follows.

A moving image is obtained (S201). This step is the same as S101 of FIG. 2.

The moving image is segmented based on scene transitions (S202). This step is the same as S102 of FIG. 2.

For each segmented scene, a moving image of the entire scene is input into the visual language model 20 to generate a caption for the moving image (S203).

The caption for the moving image is input into the large language model to extract captions for individual instances (S204).

For example, for the same moving image as in FIG. 4, the caption for the moving image acquired in step S203 is as follows:
“A scene of a park during the day is displayed. The sun is in the middle of the sky, with several clouds nearby. Trees are on the left and right sides of the image. Three benches are placed side by side in the park, and men are sitting on the left and middle benches. A man on the left bench remains seated. A man in the middle stands up and walks to the right. The sun is moving to the right. The clouds are moving to the left.”

For example, the instance captions generated in step S204 are as follows:
“Sun: The sun is positioned in the middle of the sky, moving to the right.
Clouds: Several clouds are near the sun, moving to the left.
Trees: Trees are located on the right and left sides of the image.
Benches: Three benches are placed side by side in the park.
Man on the left bench: The man is sitting on the left bench and remaining still.
Man on the middle bench: The man is initially sitting on the middle bench, but then stands up and walks to the right.”

As described above, the technology for generating instance captions from a caption for an entire image can often utilize only general information on the entire image, resulting in the generation of only a short descriptive sentence and/or an abstract descriptive sentence for each instance. Therefore, the instance captions generated from the caption for the entire moving image do not become detailed ones focused on individual instances. Even if the instance captions that are generated by decomposing the caption for the entire image generated by inputting the moving image into the visual language model 20 are used as input data for training visual language models of similar performance, the recognition performance of the instances may not improve.

In the caption generation apparatus 10 and the caption generation method according to the embodiment of the present disclosure, the instances 42 extracted by the bounding boxes 43 in each frame are provided to the visual language model 20 to generate the frame-level instance captions. Then, such frame-level instance captions are combined to generate the moving image-level instance captions. Therefore, compared to the above comparative example, it is possible to acquire more detailed captions for instances. Therefore, the instance captions generated by the caption generation apparatus 10 of the present disclosure can be suitably used for the purpose of training visual language models in a learning phase to enhance the recognition accuracy of instances.

The instance captions generated by the caption generation apparatus 10 of the present disclosure are not limited to the machine learning applications for the visual language models, and may be utilized for other purposes as long as descriptive sentences of instances are generated from a moving image.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.
[Appendix 1] A caption generation apparatus for generating a caption for an instance in a moving image, the caption generation apparatus comprising:
   an acquisition interface configured to acquire a moving image; and
   a controller configured to:
      segment the acquired moving image based on a scene transition;
      detect an instance in one of multiple frames included in each segmented scene;
      track the instance across multiple frames included in a same scene;
      assign a caption to the instance in each frame included in the same scene; and
      combine multiple captions that are assigned to the same instance in the multiple individual frames included in the same scene.
[Appendix 2] The caption generation apparatus according to appendix 1, wherein the caption for the instance is used for training a machine learning model designed for text information and moving image information.
[Appendix 3] The caption generation apparatus according to appendix 1 or 2, wherein the controller is configured to detect the instance in a frame located in a temporal middle among the multiple frames included in each segmented scene.
[Appendix 4] The caption generation apparatus according to appendix 3, wherein the controller is configured to assign a caption to every instance detectable in the frame located in the temporal middle.
[Appendix 5] The caption generation apparatus according to any one of appendices 1 to 4, wherein the controller is configured to track the instance using a bounding box that indicates an area enclosing the instance in each frame.
[Appendix 6] The caption generation apparatus according to appendix 5, wherein the controller is configured to acquire the caption assigned to each instance using a visual language model that is capable of generating a caption from an image.
[Appendix 7] The caption generation apparatus according to appendix 6, wherein the controller is configured to acquire the caption by inputting, into the visual language model, an image within the bounding box for each frame.
[Appendix 8] The caption generation apparatus according to any one of appendices 1 to 7, wherein the controller is configured to combine, using a large language model, the multiple captions assigned to the same instance in the multiple frames.
[Appendix 9] A caption generation method executed by a controller of a caption generation apparatus for generating a caption for an instance in a moving image, the caption generation method comprising:
   acquiring a moving image;
   segmenting the acquired moving image based on a scene transition;
   detecting an instance in one of multiple frames included in each segmented scene;
   tracking the instance across multiple frames included in a same scene;
   assigning a caption to the instance in each frame included in the same scene; and
   combining multiple captions that are assigned to the same instance in the multiple individual frames included in the same scene.
[Appendix 10] The caption generation method according to appendix 9, wherein the caption for the instance is used for training a machine learning model designed for text information and moving image information.
[Appendix 11] The caption generation method according to appendix 9 or 10, wherein the controller is configured to detect the instance in a frame located in a temporal middle among the multiple frames included in each segmented scene.
[Appendix 12] The caption generation method according to appendix 11, wherein the controller is configured to assign a caption to every instance detectable in the frame located in the temporal middle.
[Appendix 13] The caption generation method according to any one of appendices 9 to 12, wherein the controller is configured to track the instance using a bounding box that indicates an area enclosing the instance in each frame.
[Appendix 14] The caption generation method according to appendix 13, wherein the controller is configured to generate the caption assigned to each instance using a visual language model that is capable of generating a caption from an image.
[Appendix 15] The caption generation method according to appendix 14, wherein the controller is configured to generate the caption by inputting, into the visual language model, an image within the bounding box for each frame.
[Appendix 16] The caption generation method according to any one of appendices 9 to 15, comprising combining, using a large language model, the multiple captions assigned to the same instance in the multiple frames.
[Appendix 17] A program configured to cause a controller of a caption generation apparatus for generating a caption for an instance in a moving image to execute operations, the operations comprising:
   acquiring a moving image;
   segmenting the acquired moving image based on a scene transition;
   detecting an instance in one of multiple frames included in each segmented scene;
   tracking the instance across multiple frames included in a same scene;
   assigning a caption to the instance in each frame included in the same scene; and
   combining multiple captions that are assigned to the same instance in the multiple individual frames included in the same scene.
[Appendix 18] The program according to appendix 17, wherein the caption for the instance is used for training a machine learning model designed for text information and moving image information.
[Appendix 19] The program according to appendix 17 or 18, wherein the controller is configured to detect the instance in a frame located in a temporal middle among the multiple frames included in each segmented scene.
[Appendix 20] The program according to any one of appendices 17 to 19, wherein the controller is configured to track the instance using a bounding box that indicates an area enclosing the instance in each frame.

1. A caption generation apparatus for generating a caption for an instance in a moving image, the caption generation apparatus comprising:
an acquisition interface configured to acquire a moving image; and
a controller configured to:
segment the acquired moving image based on a scene transition;
detect an instance in one of multiple frames included in each segmented scene;
track the instance across multiple frames included in a same scene;
assign a caption to the instance in each frame included in the same scene; and
combine multiple captions that are assigned to the same instance in the multiple individual frames included in the same scene.

2. The caption generation apparatus according to claim 1, wherein the caption for the instance is used for training a machine learning model designed for text information and moving image information.

3. The caption generation apparatus according to claim 1, wherein the controller is configured to detect the instance in a frame located in a temporal middle among the multiple frames included in each segmented scene.

4. The caption generation apparatus according to claim 3, wherein the controller is configured to assign a caption to every instance detectable in the frame located in the temporal middle.

5. The caption generation apparatus according to claim 1, wherein the controller is configured to track the instance using a bounding box that indicates an area enclosing the instance in each frame.

6. The caption generation apparatus according to claim 5, wherein the controller is configured to acquire the caption assigned to each instance using a visual language model that is capable of generating a caption from an image.

7. The caption generation apparatus according to claim 6, wherein the controller is configured to acquire the caption by inputting, into the visual language model, an image within the bounding box for each frame.

8. The caption generation apparatus according to claim 1, wherein the controller is configured to combine, using a large language model, the multiple captions assigned to the same instance in the multiple frames.

9. A caption generation method executed by a controller of a caption generation apparatus for generating a caption for an instance in a moving image, the caption generation method comprising:
acquiring a moving image;
segmenting the acquired moving image based on a scene transition;
detecting an instance in one of multiple frames included in each segmented scene;
tracking the instance across multiple frames included in a same scene;
assigning a caption to the instance in each frame included in the same scene; and
combining multiple captions that are assigned to the same instance in the multiple individual frames included in the same scene.

10. The caption generation method according to claim 9, wherein the caption for the instance is used for training a machine learning model designed for text information and moving image information.

11. The caption generation method according to claim 9, wherein the controller is configured to detect the instance in a frame located in a temporal middle among the multiple frames included in each segmented scene.

12. The caption generation method according to claim 11, wherein the controller is configured to assign a caption to every instance detectable in the frame located in the temporal middle.

13. The caption generation method according to claim 9, wherein the controller is configured to track the instance using a bounding box that indicates an area enclosing the instance in each frame.

14. The caption generation method according to claim 13, wherein the controller is configured to generate the caption assigned to each instance using a visual language model that is capable of generating a caption from an image.

15. The caption generation method according to claim 14, wherein the controller is configured to generate the caption by inputting, into the visual language model, an image within the bounding box for each frame.

16. The caption generation method according to claim 9, comprising combining, using a large language model, the multiple captions assigned to the same instance in the multiple frames.

17. A non-transitory computer readable medium storing a program configured to cause a controller of a caption generation apparatus for generating a caption for an instance in a moving image to execute operations, the operations comprising:
acquiring a moving image;
segmenting the acquired moving image based on a scene transition;
detecting an instance in one of multiple frames included in each segmented scene;
tracking the instance across multiple frames included in a same scene;
assigning a caption to the instance in each frame included in the same scene; and
combining multiple captions that are assigned to the same instance in the multiple individual frames included in the same scene.

18. The non-transitory computer readable medium according to claim 17, wherein the caption for the instance is used for training a machine learning model designed for text information and moving image information.

19. The non-transitory computer readable medium according to claim 17, wherein the controller is configured to detect the instance in a frame located in a temporal middle among the multiple frames included in each segmented scene.

20. The non-transitory computer readable medium according to claim 17, wherein the controller is configured to track the instance using a bounding box that indicates an area enclosing the instance in each frame.
